(19) United States
(12) Patent Application Publication
(10) Pub. No.: US 2024/0311785 A1
(43) Pub. Date: Sep. 19, 2024

(54) POINT-OF-SALE SYSTEM AND STORE SERVER

(71) Applicant: Toshiba Tec Kabushiki Kaisha, Tokyo (JP)

(72) Inventors: Hikaru KOMIYAMA, Yokohama Kanagawa (JP); Kanako NAKAHARA, Shinagawa Tokyo (JP)

(21) Appl. No.: 18/509,192

(22) Filed: Nov. 14, 2023

(30) Foreign Application Priority Data
Mar. 17, 2023 (JP) 2023-042939

(51) Int. Cl. G06Q 20/20; B62B 3/14

(52) U.S. Cl. CPC G06Q 20/20; B62B 3/1424

(57) ABSTRACT

A POS system for managing a status of payment processing at a store includes a POS terminal configured to register an item and communicate with a payment management server to perform payment processing for the item, and a store server including an interface configured to communicate with the terminal and server, and a processor configured to: acquire a payment start request issued by the terminal, control the interface to transmit, to the server, a query regarding a status of the payment processing corresponding to the request, determine whether the status is complete, and upon determining that the status is not complete, control the interface to transmit information indicating a code that identifies the payment processing to the POS terminal, which displays the information upon receipt thereof.

### CROSS-REFERENCE TO RELATED APPLICATION(S)

This application is based upon and claims the benefit of priority from Japanese Patent Application No. 2023-042939, filed Mar. 17, 2023, the entire contents of which are incorporated herein by reference.

### FIELD

Embodiments described herein relate generally to a point-of-sale (POS) system and a store server.

### BACKGROUND

In recent years, a cart POS system in which a POS device is attached to a shopping cart and a smartphone POS system have become popular. It has also become popular to link an online payment system to such a cart POS system or smartphone POS system.

When a payment is made for a retail store online, the online payment processing may not be completed correctly due to various reasons. In such a case, the retail store is unable to know the completion status of the payment processing, and therefore there is a possibility that double payment is made.

Therefore, there is a demand for a technology that enables a seller such as a retail store to easily check the completion status of online payment processing and prevents double payment.

### SUMMARY OF THE INVENTION

Embodiments of the present invention provide an information processing apparatus, an information processing terminal, and an information processing program that can assist status check of online payment processing.

In one embodiment, a POS system for managing a status of payment processing performed at a store, comprises a POS terminal configured to register an item for purchase and communicate with a payment management server to perform payment processing for the registered item, and a store server including: a communication interface configured to communicate with the POS terminal and the payment management server, and a processor configured to: acquire a payment start request issued by the POS terminal, control the communication interface to transmit, to the payment management server, a query regarding a status of the payment processing corresponding to the payment start request, determine whether the status of the payment processing is complete, and upon determining that the status of the payment processing is not complete, control the communication interface to transmit information indicating a code that identifies the payment processing to the POS terminal. The POS terminal is configured to display the information upon receipt thereof.

### BRIEF DESCRIPTION OF THE DRAWINGS

FIG. 1 is a diagram of an information processing system according to an embodiment.

FIG. 2 is a hardware block diagram of a store server according to an embodiment.

FIG. 3 is a hardware block diagram of a POS terminal according to an embodiment.

FIG. 4 is a hardware block diagram of a store clerk terminal according to an embodiment.

FIG. 5 is a schematic diagram of a payment method selection screen displayed by the POS terminal.

FIG. 6 is a schematic diagram illustrating a notification screen displayed by the POS terminal.

FIG. 7 is a schematic diagram of a status check screen displayed by the store clerk terminal.

FIG. 8 is a schematic diagram of a detailed information check screen displayed by the store clerk terminal.

FIG. 9 is a sequence diagram of information processing performed by the information processing system.

### DETAILED DESCRIPTION

Hereinafter, embodiments will be described with reference to the drawings. In the drawings, the same components are denoted by the same reference numerals as much as possible, and redundant description will be omitted.

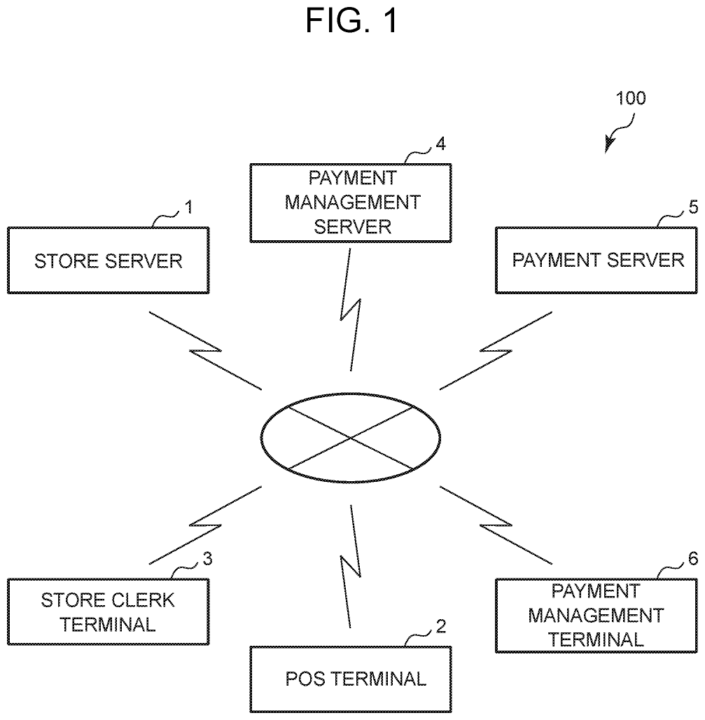

FIG. 1 is a block diagram illustrating an information processing system 100 according to an embodiment.

The information processing system 100 includes a store server 1, a POS terminal 2, a store clerk terminal 3, a payment management server 4, a payment server 5, and a payment management terminal 6. The store server 1, the POS terminal 2, the store clerk terminal 3, the payment management server 4, the payment server 5, and the payment management terminal 6 are communicably connected to each other via a network. For example, the network may comprise one or more different networks, such as the Internet, a mobile communication network, and a Local Area Network (LAN). The one or more networks may include a wireless network or may include a wired network. The information processing system 100 may also refer to a system including at least two of the store server 1, the POS terminal 2, the store clerk terminal 3, the payment management server 4, the payment server 5, and the payment management terminal 6.

The store server 1 is an information processing apparatus such as a computer that collects data and processes the collected data. The store server 1 is communicably connected to the POS terminal 2, the store clerk terminal 3, and the payment management server 4 via a network. The store server 1 receives various data from the POS terminal 2, the store clerk terminal 3, and the payment management server 4, and outputs various data to the POS terminal 2, the store clerk terminal 3, and the payment management server 4. The store server 1 may be a cloud server. Here, a part of the information processing function performed in the POS terminal 2 may be provided on the cloud. A configuration example of the store server 1 will be described later.

The POS terminal 2 is an information processing terminal capable of communicating with other electronic devices. The POS terminal 2 is, for example, a device used by a customer who shops in a store. The POS terminal 2 is a device capable of performing item registration operations such as registration, quantity change, and cancellation. For example, the customer registers an item to be purchased using a camera built in or externally connected to the POS terminal 2 or a scanner to read an identification code of the item or the like. The item registration may be performed based on an item master database stored in the POS terminal 2. In an embodiment, the POS terminal 2 searches the item master database for item information corresponding to the acquired identification code of the item. The POS terminal 2 registers the acquired item information as transaction information.

Alternatively, item registration may be performed using an item master database stored in the store server 1. In such a case, the POS terminal 2 outputs the acquired identification code of an item to the store server 1 as a registration request. The store server 1 searches the item master database for item information corresponding to the acquired identification code of the item. The store server 1 registers the acquired identification code of the item as transaction information.

For example, the customer operates the POS terminal 2 to cancel a registered item, change its quantity, or the like. The POS terminal 2 is a device capable of performing a payment process operation on an item to be purchased. For example, the POS terminal 2 is a device capable of processing electronic payment based on communication with the payment server 5. The customer can make a payment using the online payment system by operating the POS terminal 2. The POS terminal 2 may be mounted on a shopping cart and used, or may be a terminal that is used without being mounted on a shopping cart. The POS terminal 2 may be rented out at a store or owned by a user. The POS terminal 2 is a personal computer (PC), a smartphone, a tablet terminal, or the like. A customer may be read as a user of the POS terminal 2. An exemplary configuration of the POS terminal 2 will be described later. A plurality of POS terminals 2 may be provided in one store.

The store clerk terminal 3 is an information processing terminal capable of communicating with other electronic devices. The store clerk terminal 3 is, for example, a device used by a store clerk who monitors and assists a customer in a store. The store clerk terminal 3 is a device capable of managing the payment processing status of the POS terminal 2 capable of processing electronic payment based on communication with the payment server 5. The store clerk terminal 3 is a device that does not communicate with the payment management server 4. For example, the store clerk terminal 3 is a PC, a smartphone, a tablet terminal, or the like. A store clerk may be read as an attendant or a user of the store clerk terminal 3. A plurality of store clerk terminals 3 may be provided in one store.

The payment management server 4 is an electronic device that collects data and processes the collected data. The electronic device includes a computer. The payment management server 4 is communicably connected to the POS terminal 2 and the payment server 5 via a network. The payment management server 4 performs information processing for managing a sales transaction process for processing a sales transaction for buying and selling an item between a user and a store. The payment management server 4 is, for example, a cloud server, and manages payment processing in a plurality of stores. Specifically, the payment management server 4 accesses the payment server 5 that provides the online payment system, and relays the payment process using the online payment system. The payment management server 4 is, for example, a server for an online payment that connects with the store server 1 and the payment server 5 and enables smartphone payment using the POS terminal 2. For example, the payment management server 4 may function as a website hosting server that relays data between the POS terminal 2 and the payment server 5 and allows a customer to choose a payment method using the POS terminal 2.

The payment server 5 is, for example, a server that provides an online payment service. The payment server 5 performs payment processing based on an instruction from the payment management server 4. The payment server 5 performs transaction processing for processing a sales transaction of an item between a customer and a store. The payment server 5 is, for example, a cloud server, and performs transaction processing for a plurality of stores.

The payment management terminal 6 is an electronic device capable of communicating with other electronic devices. The payment management terminal 6 is, for example, a device used by a store clerk in a store. For example, the payment management terminal 6 is a PC, a smartphone, a tablet terminal, or the like. The store clerk accesses the payment management server 4 via the payment management terminal 6, and manages a payment processing status indicating a status of payment processing. The payment management terminal 6 is a device for the store clerk to inquire the payment management server 4 about the payment processing status. The payment process status indicates a status of an electronic payment based on the communication between POS terminal 2 and the payment servers 5. An electronic payment is also called as an online payment. An electronic payment based on communication between the POS terminal 2 and the payment server 5 is done without any checkout machine.

A checkout machine is installed in a store and executes payment processing related to the checkout of a transaction processed by the POS terminal 2. The checkout machine is a terminal device that accepts an operation of a user related to a payment at the time of payment processing. The checkout machine may be, for example, a well-known self-service POS terminal or a well-known face-to-face POS terminal. Payments via a checkout machine includes an online payment by non-cash, e.g., a credit card, a debit card, electronic money, a barcode, or points, and an offline payment by cash.

The payment processing status indicates “not started,” “completed,” and “not completed” of the online payment. “Completed” indicates that the payment process has been properly completed. “Not completed” indicates that the payment process has not been completed properly. “Not completed” includes that the payment process has not been completed properly due to an error such as a shortage of a balance, an excess of a max usage limit, and an authentication failure. A shortage of a balance indicates that a customer's balance of electronic money is insufficient, for example, in the electronic money payment. An excess of a max usage limit indicates, for example, that the usage limit of a customer's credit card is exceeded in the credit card payment. The authentication failure indicates, for example, that authentication using a credit card number, a security code, or the like could not be performed in the credit card payment. “Not completed status” includes, for example, a state in which it is unknown whether payment processing has been appropriately completed due to a communication failure or the like. That is, an unknown transaction has occurred in which the payment status is unknown. Hereinafter, the payment processing status is also referred to as the payment status or status.

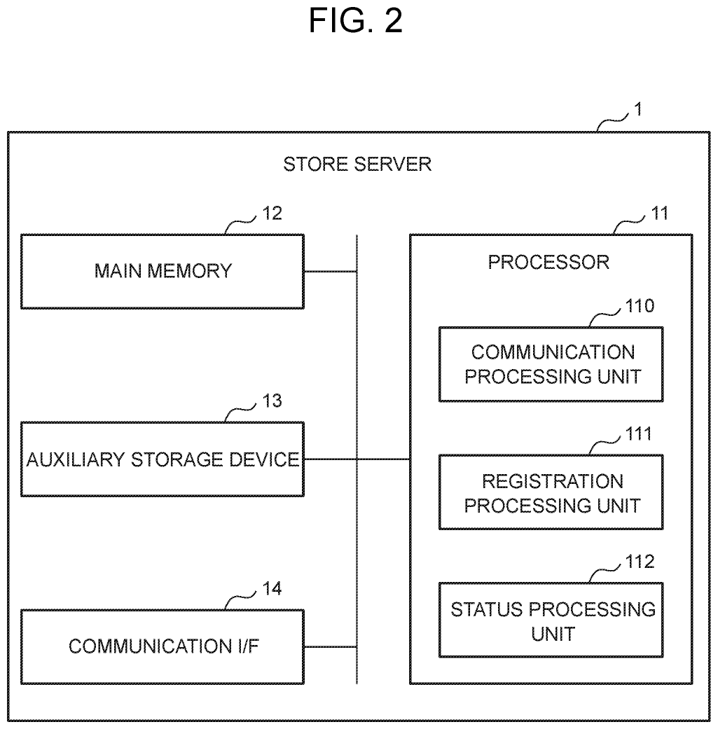

A configuration example of the store server 1 will be described. FIG. 2 is a hardware block diagram of the store server 1 according to an embodiment.

The store server 1 is an electronic device including a processor 11, a main memory 12, an auxiliary storage device 13, and a communication interface (I/F) 14. Those components constituting the store server 1 are connected to each other so as to be able to input and output signals.

The processor 11 is a core component of the store server 1. The processor 11 is an element constituting a controller of the store server 1. For example, the processor 11 is a central processing unit (CPU), but is not limited thereto. The processor 11 may be configured by various circuits. The processor 11 loads a program stored in advance in the auxiliary storage device 13 into the main memory 12. The program is executed by the processor 11 of the store server 1 to perform the functions described later. The processor 11 executes various operations by executing programs loaded into the main memory 12.

The main memory 12 is an element constituting the controller of the store server 1. The main memory 12 includes a non-volatile memory area and a volatile memory area. The non-volatile memory area of the main memory 12 stores an operating system and/or programs. The volatile memory area of the main memory 12 is used as a work area in which data is rewritten by the processor 11. For example, the non-volatile memory area of the main memory 12 includes a read only memory (ROM). For example, the volatile memory area of the main memory 12 includes a random access memory (RAM).

The auxiliary storage device 13 is an element constituting the controller of the store server 1. The auxiliary storage device 13 is an electric erasable programmable read-only memory (EEPROM), a hard disc drive (HDD), or a solid state drive (SSD). The auxiliary storage device 13 stores the above-described programs, data used by the processor 11 in performing various types of processing, and data generated by processing by the processor 11.

The auxiliary storage device 13 stores transaction information for one or more POS terminals 2. The transaction information is information on a transaction process performed by each of the POS terminals 2. Each transaction information includes a store code, a terminal code, a transaction code, a transaction status, and transaction detail information. The transaction code is unique identification information assigned to each transaction. The transaction status indicates the status of the transaction. The status of the transaction include, for example, in-store, in-shopping, in-payment, out-of-store, or the like. In-store indicates a status from the start of use to the first item registration processing is performed. In-shopping indicates the status that the POS terminal 2 is performing item registration processing. In-payment indicates the status that the transaction of the POS terminal 2 is being processed for payment. Out-of-store indicates the status that the transaction processing such as the registration processing and the payment processing of the item has been completed with respect to the transaction of the POS terminal 2. The transaction detail information includes information of registered items (hereinafter, item information) and the like. The item information includes item identification information, the quantity of each item, the price of each item, and the like. The item identification information is unique identification information assigned to each item in order to identify the item. The transaction detail information may include payment processing information. The payment processing information may include a payment processing status. The transaction detail information may be updated based on a user operation of the POS terminal 2.

The communication interface 14 includes various interface circuits for communicably connecting the store server 1 to other electronic devices via a network according to a predetermined communication protocol.

The hardware configuration of the store server 1 is not limited to the above-described configuration. One or more of the above-described components of the server 1 may be omitted or modified, and one or more new components may be added thereto as appropriate.

Functional units achieved by the above-described processor 11 will be described. The processor 11 performs the functions of a communication processing unit 110, a registration processing unit 111, and a status processing unit 112. Each unit can be achieved by the controller including the processor 11 and the main memory 12.

The communication processing unit 110 processes communication with the POS terminal 2 via the communication interface 14. The communication processing unit 110 outputs information to the POS terminal 2 via the communication interface 14. The communication processing unit 110 acquires information from the POS terminal 2 via the communication interface 14. The communication processing unit 110 processes communication with the store clerk terminal 3 via the communication interface 14. The communication processing unit 110 outputs information to the store clerk terminal 3 via the communication interface 14. The communication processing unit 110 acquires information from the store clerk terminal 3 via the communication interface 14.

The registration processing unit 111 performs item registration processing based on an item registration request from the POS terminal 2. Upon acquiring the item registration request from the POS terminal 2, the registration processing unit 111 acquires item information from the item master database based on item identification information included in the item registration request, and records the item information in transaction information. The item master database stores item identification information and item information of each item sold in the store in association with each other. The item information includes an item name, a price, and the like.

The status processing unit 112 executes information processing related to a payment processing status. The status processing unit 112 executes information processing related to the payment processing status on the basis of a result of an inquiry of the payment processing status to the payment management server 4 via the communication processing unit 110.

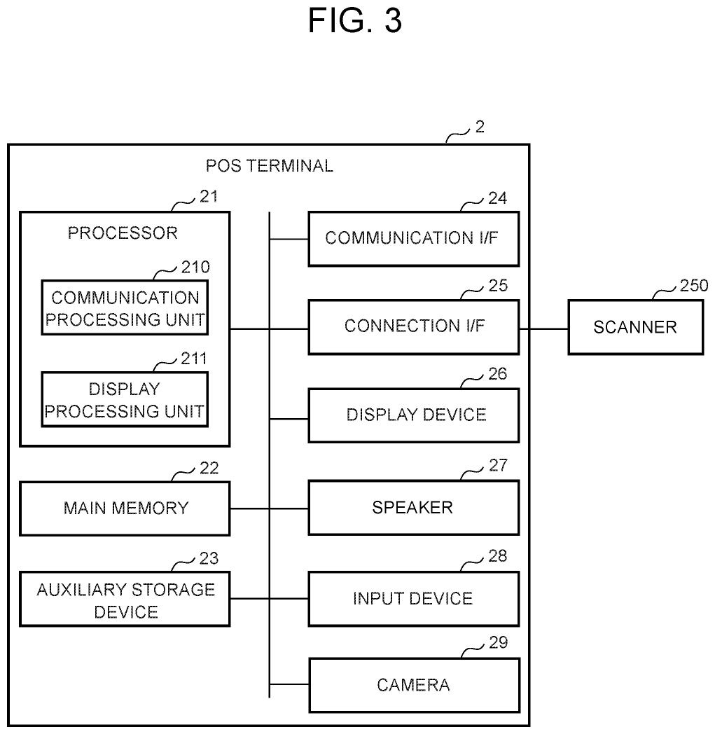

A configuration of the POS terminal 2 will be described. FIG. 3 is a hardware block diagram of the POS terminal 2 according to an embodiment.

The POS terminal 2 is an electronic device including a processor 21, a main memory 22, an auxiliary storage device 23, a communication interface 24, a connection interface 25, a display device 26, a speaker 27, an input device 28, and a camera 29. Those components constituting the POS terminal 2 are connected to each other so as to be capable of inputting/outputting signals. The POS terminal 2 registers an item to be purchased by reading its item identification code or the like by the input device 28 or the camera 29. The POS terminal 2 performs an item registering process and a payment process on the basis of a user operation.

The processor 21 is a core component of the POS terminal 2. The processor 21 is an element constituting a controller of the POS terminal 2. The processor 21 has a hardware configuration similar to that of the processor 11 described above. The processor 21 executes various operations by executing programs stored in advance in the main memory 22 or the auxiliary storage device 23.

The main memory 22 is an element constituting the controller of the POS terminal 2. The main memory 22 has the same hardware configuration as that of the main memory 12 described above.

The auxiliary storage device 23 is an element constituting the controller of the POS terminal 2. The auxiliary storage device 23 has the same hardware configuration as that of the auxiliary storage device 13 described above.

The auxiliary storage device 23 stores transaction information of the POS terminal 2. The transaction information includes identification information and the like of the POS terminal 2. The identification information of the POS terminal 2 is unique identification information assigned to each POS terminal 2 in order to identify the POS terminals 2. The identification information of the POS terminal 2 includes an IP address and the like of the POS terminal 2. The transaction information may include user identification information of the user of the POS terminal 2. The user identification information is unique identification information assigned to each user in order to individually identify the user.

The communication interface 24 includes various interface circuits for communicably connecting the POS terminal 2 to other devices via a network according to a predetermined communication protocol. For example, the POS terminal 2 and the external device are communicably connected via a network. The network may include a wireless network or may include a wired network. The network includes, for example, a LAN, a network using Bluetooth® or Wi-Fi®, etc.

The connection interface 25 is an interface circuit for wired connection between the POS terminal 2 and an external device. The external device includes a scanner 250.

The display device 26 is capable of displaying various screens under the control of the processor 21. For example, the display device 26 may be a liquid crystal display (LCD) or an Electroluminescence (EL) display.

The speaker 27 is a device capable of outputting sound under the control of the POS terminal 2. The speaker 27 is an example of an audio output device.

The input device 28 is a device capable of inputting data or instructions to the POS terminal 2. The input device 28 may include a keyboard, a touch panel, or the like. The input device 28 may include a scanner. A customer can register an item to be purchased by operating the scanner to read an identification code of the item.

The camera 29 is a device capable of acquiring an image of an item within a photographing range, e.g., in a shopping cart. A customer can register such an item to be purchased by operating the camera 29 to read an identification code of the item.

The hardware configuration of the POS terminal 2 is not limited to the above-described configuration. One or more of the above-described components of the POS terminal 2 may be omitted or modified, and one or more new components may be added thereto as appropriate.

Functional units achieved by the above-described processor 21 will be described. The processor 21 performs the functions of a communication processing unit 210 and a display processing unit 211. Each unit can also be achieved by the controller including the processor 21 and the main memory 22. The processor 21 performs item registration processing and payment processing. The processor 21 functions as the communication processing unit 210 and the display processing unit 211 in the payment processing.

The communication processing unit 210 processes communication with the store server 1 via the communication interface 24. The communication processing unit 210 outputs information to the store server 1 via the communication interface 24. The communication processing unit 210 acquires information from the store server 1 via the communication interface 24. The communication processing unit 210 processes communication with the payment management server 4 via the communication interface 24. The communication processing unit 210 outputs information to the payment management server 4 via the communication interface 24. The communication processing unit 210 acquires information from the payment management server 4 via the communication interface 24.

The display processing unit 211 controls the display device 26 to display an image. The display processing unit 211 may control the display device 26 to display a screen based on the user's processing.

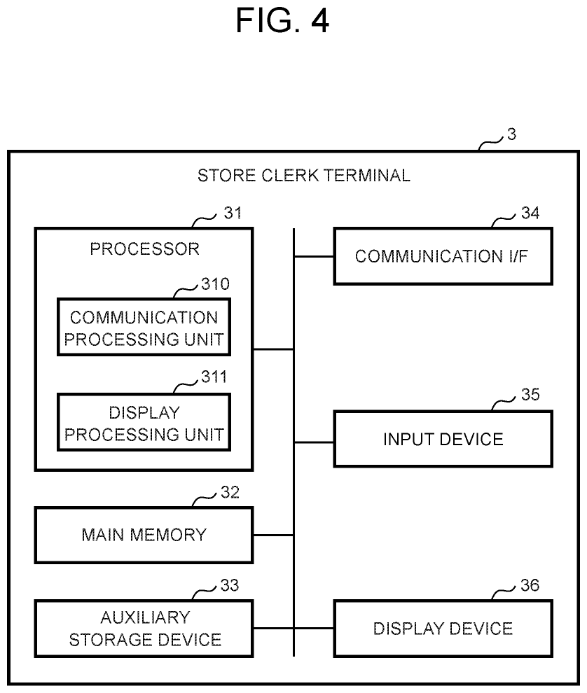

A configuration example of the store clerk terminal 3 will be described. FIG. 4 is a hardware block diagram of the store clerk terminal 3 according to an embodiment.

The store clerk terminal 3 is an electronic device including a processor 31, a main memory 32, an auxiliary storage device 33, a communication interface 34, an input device 35, and a display device 36. Those components constituting the store clerk terminal 3 are connected to each other so as to be able to input and output signals.

The processor 31 is a core component of the store clerk terminal 3. The processor 31 is an element constituting a controller of the store clerk terminal 3. The processor 31 has a hardware configuration similar to that of the processor 11 described above. The processor 31 executes various operations by executing programs stored in advance in the main memory 32 or the auxiliary storage device 33.

The main memory 32 is an element constituting the controller of the store clerk terminal 3. The main memory 32 has the same hardware configuration as that of the main memory 12 described above.

The auxiliary storage device 33 is an element constituting the controller of the store clerk terminal 3. The auxiliary storage device 33 has the same hardware configuration as the auxiliary storage device 13 described above.

The auxiliary storage device 33 may temporarily store transaction information for each of the POS terminals 2. The auxiliary storage device 33 may temporarily store payment process statuses of the POS terminals 2.

The communication interface 34 includes various interface circuits for communicably connecting the store clerk terminal 3 to other devices via a network according to a predetermined communication protocol. For example, the store clerk terminal 3 and the external device are communicably connected via a network. The network may include a wireless network or may include a wired network. The network includes, for example, a LAN, a network using Bluetooth® or Wi-Fi®, etc.

The input device 35 is a device capable of inputting data or instructions to the store clerk terminal 3. The input device 35 may include a keyboard, a touch panel, or the like.

The display device 36 is capable of displaying various screens under the control of the processor 31. For example, the display device 36 is an LCD, an EL display, or the like.

Note that the hardware configuration of the store clerk terminal 3 is not limited to the above-described configuration. One or more of the above-described components of the store clerk terminal 3 may be omitted or modified, and one or more new components may be added thereto as appropriate.

Functional units achieved by the above-described processor 31 will be described. The processor 31 performs the functions of the communication processing unit 310 and the display processing unit 311. Each unit can be achieved by the controller including the processor 31 and the main memory 32.

The communication processing unit 310 processes communication with the store server 1 via the communication interface 34. The communication processing unit 310 outputs information to the store server 1 via the communication interface 34. The communication processing unit 310 acquires information from the store server 1 via the communication interface 34.

The display processing unit 311 controls the display device 36 to display an image. The display processing unit 311 may control the display device 36 to display a screen based on the user's processing.

### [Display Example]

Screens displayed on the display device 26 of the POS terminal 2 will be described.

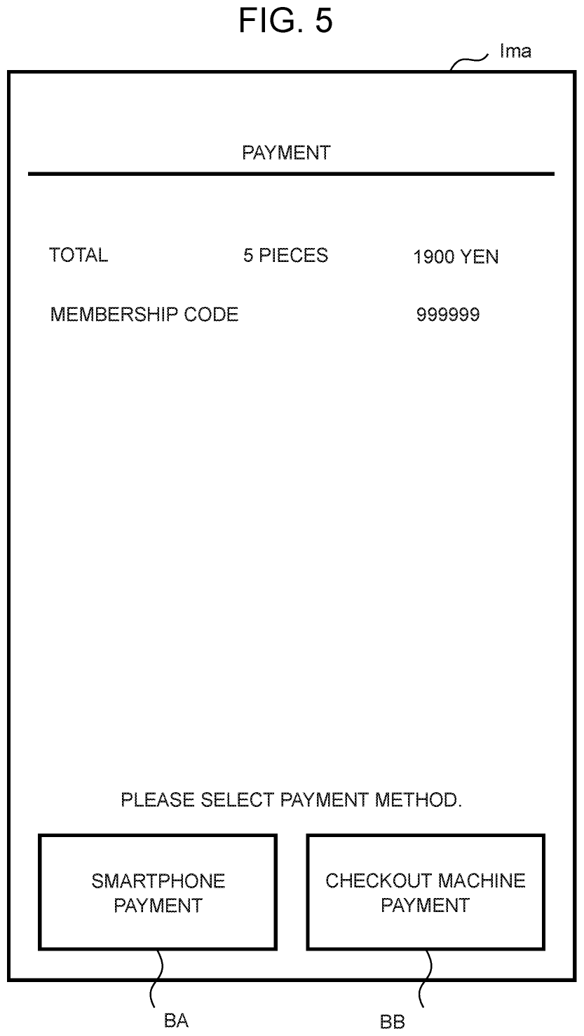

FIG. 5 is a schematic diagram illustrating an exemplary payment method selection screen Ima displayed by the POS terminal 2 according to an embodiment. A user of the POS terminal 2 registers an item via the POS terminal 2. When the item registration is completed and an operation for instructing the user to start checkout processing is performed, the payment method selection screen Ima for selecting a payment method is displayed on the display device 26 of the POS terminal 2.

The payment method selection screen Ima includes character strings indicating the total number of transaction items, a payment price, and a membership code. The membership code is unique identification information assigned to each user of the POS terminal 2. The membership code is, for example, a membership number of a user registered as a member. The payment method selection screen Ima includes buttons Ba and Bb. The button Ba is a softkey for the user to select smartphone payment. The smartphone payment is an example of online payment. The button Bb is a softkey for the user to select checkout machine payment.

When performing payment using the online payment system by operating the POS terminal 2, the user performs a predetermined operation for selecting smartphone payment by tapping the button Ba. When performing payment using a checkout machine (not shown), the user performs a predetermined operation for selecting checkout machine payment by tapping the button Bb.

When smartphone payment is selected by the user, the processor 21 of the POS terminal 2 issues a payment start request to the payment management server 4. The payment processing by the payment management server 4 may be known in an existing online payment system. When checkout machine payment is selected by the user, the processor 21 of the POS terminal 2 executes a process for causing the checkout machine to perform a payment process of the price of the transaction being processed. The payment processing by the checkout machine may be a known payment processing. For example, the processor 21 of the POS terminal 2 controls the display device 26 to display a checkout machine code for performing a transaction payment process on the checkout machine. The user causes the checkout machine to read the checkout machine code, and performs payment processing of the corresponding transaction.

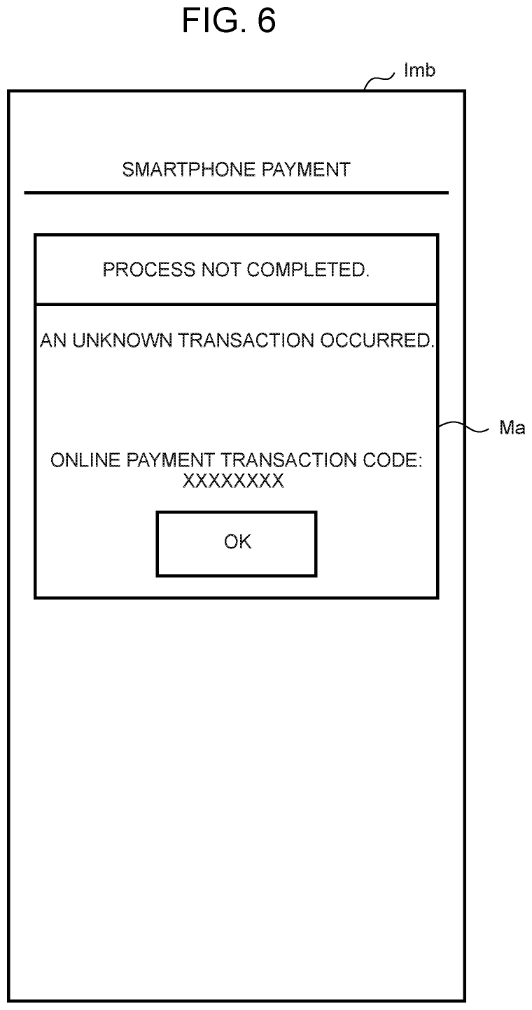

FIG. 6 is a schematic diagram illustrating an exemplary notification screen Imb displayed by the POS terminal 2 according to an embodiment.

The notification screen Imb is displayed when an online payment process is not properly completed. The notification screen Imb includes text such as “Unknown transaction occurred”. The notification screen Imb includes an online payment transaction code. The online payment transaction code is unique identification information assigned to a transaction in online payment. The online payment transaction code includes, for example, a store code, a terminal ID, a transaction code, and a code indicating a date and time. The store code is unique identification information assigned to each store. For example, the store code is a code of the store checked in by the user of the POS terminal 2. The terminal ID is identification information of the POS terminal 2. The transaction code is unique identification information for identifying a transaction assigned to each transaction. The date and time indicates when smartphone payment is selected by the user. The online payment transaction code is a code for managing the payment process in the payment management server 4. The online payment transaction code is an example of information about an unknown transaction. The online payment transaction code is issued by the payment management server 4 when smartphone payment is selected by the user of the POS terminal 2 and the POS terminal 2 cooperates with the payment management server 4. When the POS terminal 2 is a terminal mounted on a shopping cart and used, the online payment transaction code may be issued by the payment management server 4 based on the fact that the smartphone payment is selected by the user of the POS terminal 2 and a two-dimensional code linked to the payment management server 4 is displayed on the display device 26. The online payment transaction code may be any information capable of identifying a transaction in online payment, and the configuration is not limited thereto. The online payment transaction code is identification information for inquiring the payment management server 4 of the payment process status of the POS terminal 2 in which the unknown transaction is detected. The online payment transaction code may be identification information capable of identifying an unknown transaction. The online payment transaction code may be identification information capable of identifying the POS terminal 2 in which the unknown transaction is detected. The notification screen Imb may include an “OK” button. The information on the unknown transaction is information that can be displayed on the POS terminal 2 or the store clerk terminal 3 to indicate that an unknown transaction has been detected.

For example, the user of the POS terminal 2 shows the notification screen Imb to a store clerk. The store clerk checks the payment process status based on the online payment transaction code included in the notification screen Imb. Specifically, the store clerk inputs the online payment transaction code in the payment management terminal 6 and inquires of the payment management server 4 about the payment processing status. The store clerk checks the payment processing status and checks whether the payment processing of the corresponding transaction has been completed. If the transaction payment process is not completed, the store clerk asks the user to perform the payment process again. When the payment processing of the transaction has been completed a plurality of times, the store clerk instructs the payment management server 4 via the payment management terminal 6 to cancel the remaining payment processing excluding one of the plurality of payment processing that has been completed. In a case where the payment processing of the transaction has been completed a plurality of times, for example, a case where the payment processing by the payment server 5 is completed and the payment processing status is changed after an inquiry of the payment processing status is made by the store server 1 is included. Specifically, it includes a case where the payment processing is not completed in the first inquiry by the store server 1, the user performs the payment processing again, and then the payment processing by the payment server 5 is completed. Note that the store clerk may cancel the payment for the transaction in which the unknown transaction is detected.

The display processing unit 211 of the POS terminal 2 may hide the notification screen Imb after a predetermined period of time has elapsed, or may hide the notification screen Imb based on a store clerk or a user's selection of the “OK” button.

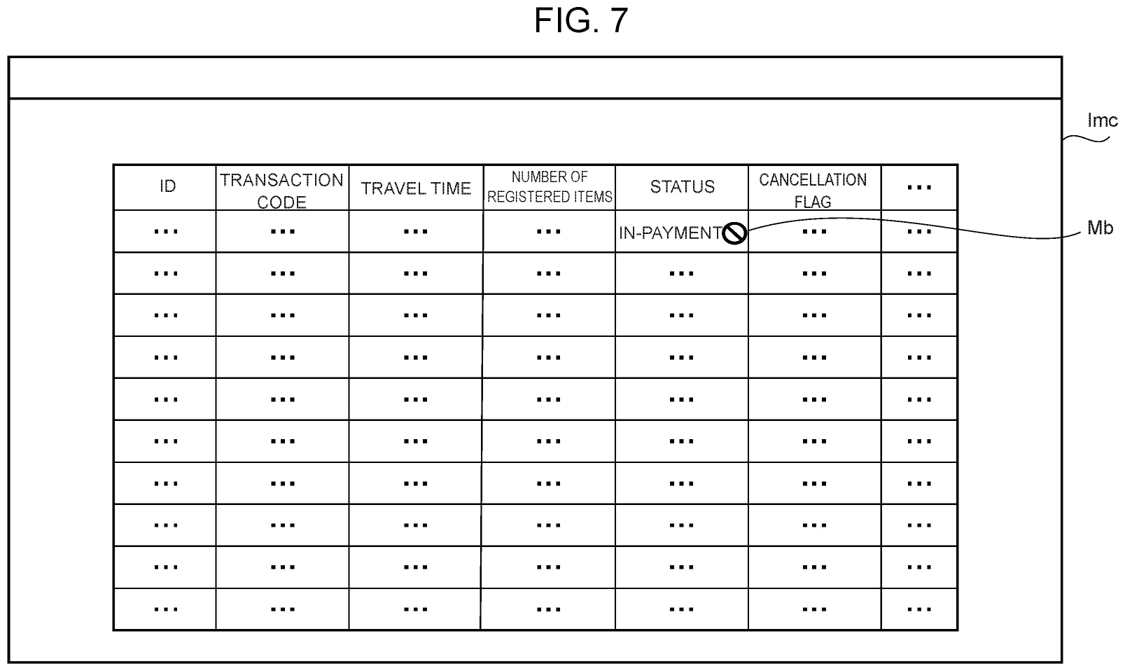

A screen displayed on the display device 36 of the store clerk terminal 3 will be described. FIG. 7 is a schematic diagram illustrating an example of a status check screen Imc displayed by the store clerk terminal 3 according to an embodiment.

FIG. 7 shows a status check screen Imc displayed on the store clerk terminal 3. The status check screen Imc is a screen for checking the status of one or more POS terminals 2.

The status check screen Imc includes a terminal ID, a transaction code, a travel time, a number of registered items, a transaction status, a cancellation flag, and the like. The terminal ID indicates identification information of each POS terminal 2. The transaction code indicates identification information for identifying transaction information. The travel time indicates a time after the user starts using the POS terminal 2. The number of registered items indicates the quantity of the items registered by the user. The transaction status indicates the status of the POS terminal 2 such as in-store, in-shopping, in-payment, and out-of-store. The cancellation flag indicates that a cancel or stop button for stopping item registration is operated after the item registration is started by the user.

The status check screen Imc includes a mark Mb indicating an error as a notification regarding an unknown transaction. The error indicates that an unknown transaction is detected. For example, the store clerk terminal 3 may display the mark Mb indicating an error in the transaction status field. The mark Mb is not limited to the mark shown in FIG. 7, and may be any mark as long as it is displayed such that a store clerk can recognize that an unknown transaction has been detected. The mark Mb may be displayed to indicate one or more of the POS terminals 2 listed on the screen and in which an unknown transaction has been detected.

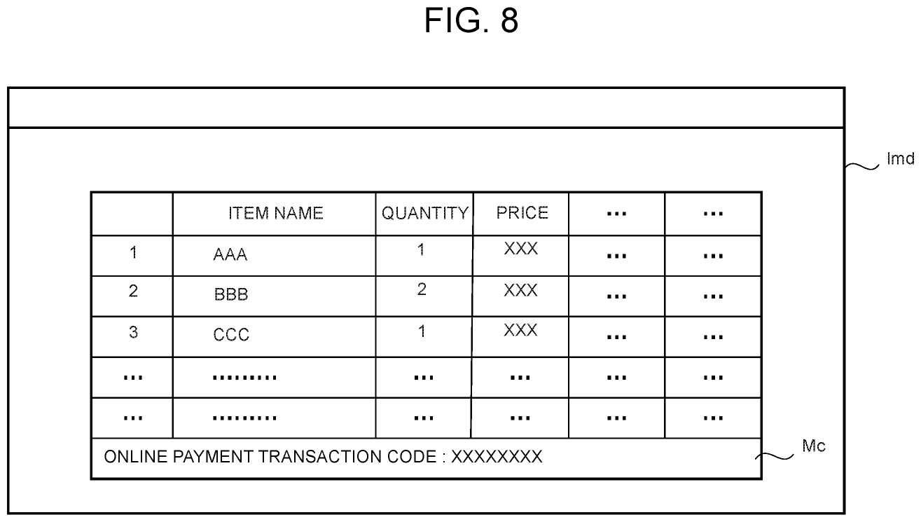

For example, the user of the store clerk terminal 3 confirms the mark Mb and the detail information of the corresponding POS terminal 2. In the status check screen Imc, when a record including the mark Mb or the mark Mb is selected by the user, a detailed information check screen Imd shown in FIG. 8 is displayed. The selection of the record including the mark Mb or the mark Mb by the user corresponds to the selection of the POS terminal 2 in which the unknown transaction is detected by the user.

FIG. 8 is a schematic diagram illustrating an example of the detailed information check screen Imd displayed by the store clerk terminal 3 according to an embodiment.

FIG. 8 shows a detailed information check screen Imd displayed on the store clerk terminal 3. The detailed information check screen Imd is displayed when one record is selected in the status check screen Imc shown in FIG. 7. The detailed information check screen Imd is a screen for confirming the status of the POS terminal 2 selected by the user of the store clerk terminal 3. The detailed information check screen Imd includes information such as an item name, a quantity, and an amount. The detailed information check screen Imd includes an online payment transaction code Mc.

For example, the user of the store clerk terminal 3 confirms the settlement process status based on the online payment transaction code included in the detailed information check screen Imd. Specifically, the store clerk inputs the online payment transaction code in the payment management terminal 6 and inquires of the payment management server 4 about the payment processing status. The store clerk checks the payment processing status and checks whether the payment processing of the corresponding transaction has been completed. If the transaction payment process is not completed, the store clerk asks the user to perform the payment process again. When the payment processing of the transaction is completed a plurality of times, the store clerk instructs the payment management server 4 to cancel the payment processing via the payment management terminal 6.

### Operation Example

Processing performed by the information processing system 100 will be described. In the description related to the store server 1 below, the described steps are performed by the store server 1 or its processor 11. Similarly, in describing the POS terminal 2, the described steps are performed by the POS terminal 2 or its processor 21. In the description that is mainly related to the store clerk terminal 3, the described steps are performed by the store clerk terminal 3 or its processor 31. The process described below is merely an example, and each step may be changed. Further, steps can be omitted, replaced, and added as appropriate according to the embodiment with respect to the processing procedure described below.

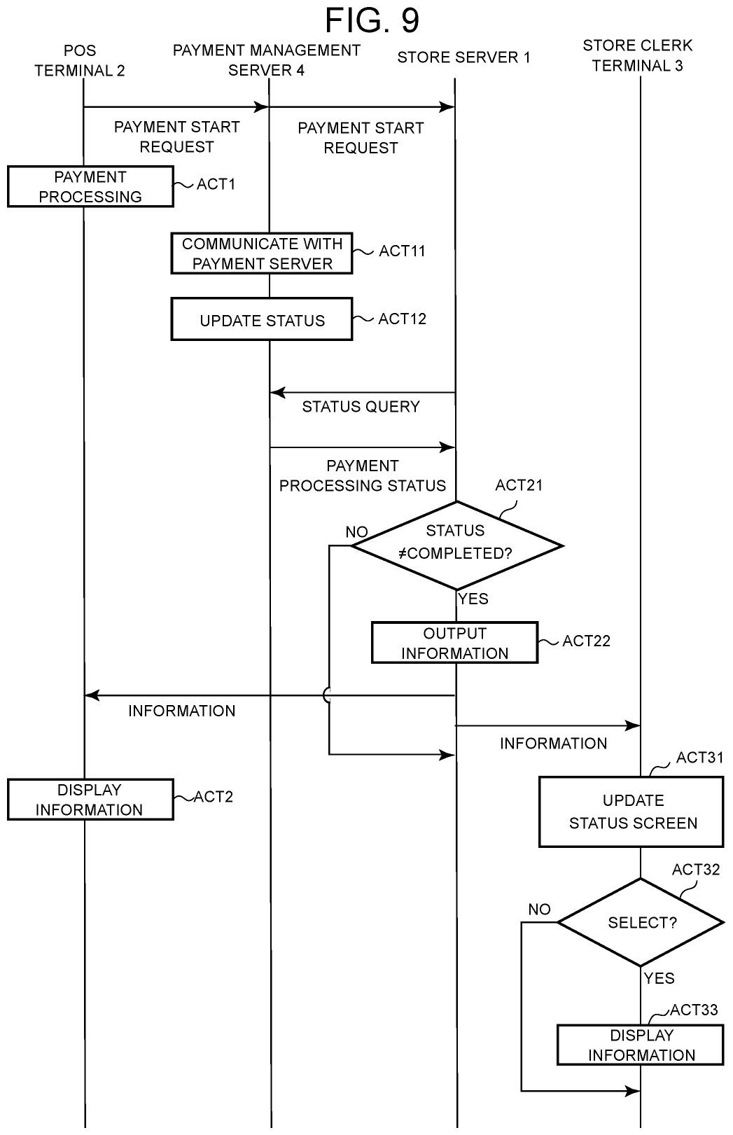

FIG. 9 is a sequence diagram exemplifying information processing by the information processing system 100 according to an embodiment. In the following process, it is assumed that the user of the POS terminal 2 shops at the store A, and smartphone payment is selected in the payment method selection screen shown in FIG. 5.

The user of the POS terminal 2 performs check-in via a check-in device installed at the entrance of the store A. For example, when the user activates a dedicated application program in the POS terminal 2, a bar code, a two-dimensional code, or the like representing the member ID is displayed on the display device 26. The user operates the check-in device to read the member ID to perform check-in. The check-in by the member ID may be performed by a known process. After performing the check-in process, the POS terminal 2 performs an item registering process based on the user operation.

It is assumed that the following process is started based on the smartphone payment being selected by the user of POS terminal 2.

The communication processing unit 210 of the POS terminal 2 issues a payment start request to the payment management server 4. The communication processing unit 210 of the POS terminal 2 may control the communication interface 24 to send the payment start request to the store server 1. For example, the communication processing unit 210 of the POS terminal 2 may control the communication interface 24 to transmit the payment start request to the store server 1 based on the smartphone payment selected by the user of the POS terminal 2. When the POS terminal 2 is mounted on a shopping cart and used, the communication processing unit 210 of the POS terminal 2 may issue the payment start request to the store server 1 when the smartphone payment is selected by the user of the POS terminal 2 and the two-dimensional code linked to the payment management server 4 is displayed on the display device 26. The store server 1 may periodically inquire of the payment management server 4 about the payment processing status with the acquisition of the payment start request as a trigger.

The POS terminal 2 performs payment processing via the payment management server 4 (ACT1).

The payment management server 4 communicates with the payment server 5 (ACT11). The payment management server 4 communicates with the payment server 5 that provides the selected payment service based on the selection by the user of the POS terminal 2. The payment server 5 performs payment processing for the transaction of the POS terminal 2. The payment server 5 outputs the payment processing status to the payment management server 4 based on the progress status of the payment processing. The payment management server 4 acquires the payment processing status. The payment management server 4 stores the payment processing status. The payment management server 4 assigns an online payment transaction code for each payment transaction. The payment management server 4 manages the payment processing status based on the online payment transaction code.

Each time the payment processing status is acquired, the payment management server 4 updates the payment processing status (ACT12).

The communication processing unit 110 of the store server 1 periodically inquires the payment management server 4 about the payment processing status. The communication processing unit 110 of the store server 1 may start a query based on the payment start request from the POS terminal 2. The communication processing unit 110 acquires the payment processing status from the payment management server 4.

The status processing unit 112 of the store server 1 determines whether the payment processing has been appropriately completed based on the acquired payment processing status (ACT21). In ACT21, for example, the status processing unit 112 determines whether the payment processing status indicates “completed”. When the status processing unit 112 determines that the payment processing status is not “completed” (ACT21: YES), the processing transitions from ACT21 to ACT22. When the status processing unit 112 determines that the payment processing status is “completed” (ACT21: NO), the processing ends.

The communication processing unit 110 of the store server 1 controls the communication interface 14 to output information regarding an unknown transaction when the payment processing status is determined not to be “completed” by the status processing unit 112 (ACT22). The determination that the payment processing status is not “completed” corresponds to detection of an unknown transaction. In ACT22, for example, the communication processing unit 110 controls the communication interface 14 to output an online payment transaction code to the POS terminal 2. The communication processing unit 110 controls the communication interface 14 to output to the store clerk terminal 3 information to be displayed thereon such that it can be recognized that an unknown transaction has been detected. For example, the output information causes the display device 36 of the store clerk terminal 3 to display a mark indicting that an unknown transaction has been detected. The communication processing unit 110 controls the communication interface 14 to output an online payment transaction code to the store clerk terminal 3. The communication processing unit 110 may control the communication interface 14 to output the information for displaying the mark on the store clerk terminal 3 and the online payment transaction code at the same time, or may output them separately.

The communication processing unit 210 of the POS terminal 2 acquires information related to the unknown transaction. The display processing unit 211 of the POS terminal 2 controls the display device 26 to display information on the unknown transaction (ACT2). In ACT2, for example, the display processing unit 211 of the POS terminal 2 controls the display device 26 to display the online payment transaction code based on the information about the unknown transaction acquired from the store server 1.

The communication processing unit 310 of the store clerk terminal 3 acquires information related to the unknown transaction. The display processing unit 311 of the store clerk terminal 3 updates the status check screen Imc based on the information related to the unknown transaction (ACT31). In ACT31, for example, the display processing unit 311 controls the display device 36 to display the information on the unknown transaction acquired from the store server 1. The display processing unit 311 controls the display device 36 to display the status check screen Imc including the mark indicating that an unknown transaction has been detected.

The display processing unit 311 of the store clerk terminal 3 determines whether the POS terminal 2 in which the unknown transaction has been detected has been selected by the user of the store clerk terminal 3 (ACT32). When the display processing unit 311 determines that the POS terminal 2 in which the unknown transaction is detected is selected (ACT32: YES), the processing transitions from ACT32 to ACT33. When the display processing unit 311 determines that the POS terminal 2 for which the unknown transaction has been detected has not been selected (ACT32: NO), the processing ends.

The display processing unit 311 of the store clerk terminal 3 controls the display device 36 to display the online payment transaction code on the display device 36 based on the information about the unknown transaction acquired from the store server 1 (ACT33).

### Effect

As described above, the store server 1 can detect an unknown transaction in which a status of payment is unknown based on the communication between the POS terminal 2 and the payment server 5, and can output, to the POS terminal 2, information on the unknown transaction such that it can be recognized that the unknown transaction has been detected.

For example, the store server 1 may inquire the payment management server 4 about the payment processing status of the POS terminal 2, and, when an unknown transaction is detected based on the payment processing status, may transmit information about the unknown transaction to the POS terminal 2. The store server 1 can display, via the POS terminal 2, information regarding the unknown transaction. The user of the POS terminal 2 can receive information about the unknown transaction and query a store clerk. The store clerk may respond to the unknown transaction based on information about the unknown transaction. Further, the store server 1 can display, via the store clerk terminal 3, information related to the unknown transaction. The user of the store clerk terminal 3 is able to deal with the unknown transaction based on the displayed information. As described above, the store server 1 can assist in confirmation of the completion status of the online payment processing.

The store server 1 may output information on an unknown transaction with a mark indicating that the unknown transaction has been detected to the store clerk terminal 3. For example, the store server 1 can cause the display device 36 to display a status check screen Imc including a mark Mb via the store clerk terminal 3 as shown in FIG. 7. The user of the store clerk terminal 3 can easily recognize the POS terminal 2 in which the unknown transaction is detected by confirming the mark Mb. The user of the store clerk terminal 3 can deal with the unknown transaction more quickly. As described above, the store server 1 can assist in confirmation of the completion status of the online payment processing.

The store server 1 is capable of outputting, to the POS terminal 2, information related to an unknown transaction including identification information for inquiring about the status of payment of the POS terminal 2 in which the unknown transaction is detected. The store server 1 can display the identification information regarding the unknown transaction via the POS terminal 2. The user of POS terminal 2 may receive the identification information of the unknown transaction and query a store clerk. The store clerk can quickly deal with the unknown transaction after confirming the displayed identification information about the unknown transaction. Further, the store server 1 can display the identification information related to the unknown transaction via the store clerk terminal 3. The user of the store clerk terminal 3 can promptly deal with the unknown transaction based on the displayed identification information regarding the unknown transaction. As described above, the store server 1 can assist in confirmation of the completion status of the online payment processing.

The POS terminal 2 can acquire information on an unknown transaction in which the status of the electronic payment is unknown based on the communication between POS terminal 2 and the payment server 5, and can display information on the unknown transaction on the display device 26. For example, the POS terminal 2 may display information about the unknown transaction obtained from the store server 1 on the display device 26. The user of the POS terminal 2 can receive such information about the unknown transaction and query a store clerk. The store clerk may deal with the unknown transaction after confirming the displayed information about the unknown transaction. As described above, the POS terminal 2 can assist in checking the completion status of the online payment process.

In addition, the POS terminal 2 can display the information on the unknown transaction including the identification information for inquiring the status of the payment of the POS terminal 2 in which the unknown transaction is detected on the display device 26. The user of the POS terminal 2 may receive the identification information of the unknown transaction and query a store clerk. The store clerk can quickly deal with the unknown transaction based on the identification information about the unknown transaction.

The store clerk terminal 3 can acquire information on an unknown transaction in which a payment status is unknown based on the communication between the POS terminal 2 and the payment server 5, and can display information on the unknown transaction on the display device 36. For example, the store clerk terminal 3 may display information about an unknown transaction obtained from the store server 1 on the display device 36. The user of the store clerk terminal 3 is able to deal with the unknown transaction based on the information on the unknown transaction. As described above, the store server 1 can assist in confirmation of the completion status of the online payment processing.

In addition, the store clerk terminal 3 may display information on an unknown transaction including the identification information for inquiring the status of payment of the POS terminal 2 in which the unknown transaction is detected on the display device 26. The user of the store clerk terminal 3 can promptly deal with the unknown transaction based on the identification information regarding the unknown transaction. As described above, the store server 1 can assist in confirmation of the completion status of the online payment processing.

### Other Embodiments

The store server 1 may be realized by one electronic device or may be realized by a plurality of electronic devices each executes one or more of the functions.

In the above-described embodiment, the store clerk terminal 3 and the payment management terminal 6 are described as separate terminals, but the store clerk terminal 3 and the payment management terminal 6 may be integrated into one terminal.

The program for executing the above-described functions may be stored in each apparatus or terminal described above in advance or copied from an external device. In the latter case, the program may be transferred via a network or may be transferred from a non-transitory computer readable recording medium. The recording medium may be any form as long as it can store the program such as a CD-ROM or a memory card.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A point-of-sale (POS) system for managing a status of payment processing for items purchased at a store, comprising:
a POS terminal configured to register an item for purchase and communicate with a payment management server to perform payment processing for the registered item; and
a store server including:
a communication interface configured to communicate with the POS terminal and the payment management server, and
a processor configured to:
acquire a payment start request issued by the POS terminal,
control the communication interface to transmit, to the payment management server, a query regarding a status of the payment processing corresponding to the payment start request,
determine whether the status of the payment processing is complete, and
upon determining that the status of the payment processing is not complete, control the communication interface to transmit information indicating a code that identifies the payment processing to the POS terminal, wherein
the POS terminal is configured to display the information upon receipt thereof.

2. The POS system according to claim 1, wherein the POS terminal displays the code with a message indicating that the payment processing is incomplete.

3. The POS system according to claim 1, further comprising:
a store clerk terminal configured to manage a state of use of the POS terminal in the store, wherein
the communication interface is configured to communicate with the store clerk terminal,
the processor is configured to, upon determining that the status of the payment processing is not complete, control the communication interface to transmit information regarding the payment processing to the store clerk terminal, and
the store clerk terminal is configured to, upon receipt of the information from the store server, display a notification in association with the state of use of the POS terminal.

4. The POS system according to claim 3, wherein the store clerk terminal is configured to, upon receipt of the information from the store server, display a mark adjacent to text indicating the state of use of the POS terminal.

5. The POS system according to claim 3, wherein the store clerk terminal is configured to display, in response to an input operation, information of the item registered by the POS terminal together with the information regarding the payment processing.

6. The POS system according to claim 1, wherein the POS terminal is configured to:
display a screen through which either online payment or checkout machine payment can be selected, and
upon selection of the online payment through the screen, issue the payment start request to the payment management server.

7. The POS system according to claim 1, wherein the POS terminal is attachable to a shopping cart.

8. A store server for managing a status of payment processing performed at a store, comprising:
a communication interface configured to communicate with a point-of-sale (POS) terminal through which an item can be registered for purchase and a payment management server through which payment processing for the registered item can be performed; and
a processor configured to:
acquire a payment start request issued by the POS terminal,
control the communication interface to transmit, to the payment management server, a query regarding a status of the payment processing corresponding to the payment start request,
determine whether the status of the payment processing is complete, and
upon determining that the status of the payment processing is not complete, control the communication interface to transmit information indicating a code that identifies the payment processing to the POS terminal, wherein the information causes the POS terminal to display the information.

9. The store server according to claim 8, wherein the information causes the POS terminal to display the code with a message indicating that the payment processing is incomplete.

10. The store server according to claim 8, wherein
the communication interface is configured to communicate with a store clerk terminal through which a state of use of the POS terminal in the store can be managed, and
the processor is configured to, upon determining that the status of the payment processing is not complete, control the communication interface to transmit information regarding the payment processing to the store clerk terminal, wherein the information causes the store clerk terminal to display a notification in association with the state of use of the POS terminal.

11. The store server according to claim 10, wherein the information causes the store clerk terminal to display a mark adjacent to text indicating the state of use of the POS terminal.

12. The store server according to claim 10, wherein the information causes the store clerk terminal to display information of the item registered by the POS terminal together with the information regarding the payment processing.

13. The store server according to claim 8, wherein the processor acquires the payment start request issued by the POS terminal via the payment management server.

14. The store server according to claim 8, wherein the communication interface communicates with the POS terminal attachable to a shopping cart.

15. A point-of-sale (POS) system for managing a status of payment processing performed at a store, comprising:
a store clerk terminal configured to manage a state of use of a POS terminal through which an item can be registered for purchase in the store; and
a store server including:
a communication interface configured to communicate with the store clerk terminal, the POS terminal, and a payment management server through which payment processing for the registered item can be performed, and
a processor configured to:
acquire a payment start request issued by the POS terminal,
control the communication interface to transmit, to the payment management server, a query regarding a status of the payment processing corresponding to the payment start request,
determine whether the status of the payment processing is complete, and
upon determining that the status of the payment processing is not complete, control the communication interface to transmit information indicating a code that identifies the payment processing to the store clerk terminal, wherein
the store clerk terminal is configured to, upon receipt of the information from the store server, display a notification in association with the state of use of the POS terminal.

16. The POS system according to claim 15, wherein
the processor is configured to generate the information including a code that identifies the payment processing performed by the POS terminal, and
the store clerk terminal is configured to display the code with information of the item registered by the POS terminal.

17. The POS system according to claim 15, wherein
the processor is configured to, upon determining that the status of the payment processing is not complete, control the communication interface to transmit information regarding the payment processing to the POS terminal, and
the POS terminal is configured to display the information upon receipt thereof.

18. The POS system according to claim 15, wherein the store clerk terminal is configured to, upon receipt of the information from the store server, display a mark adjacent to text indicating the state of use of the POS terminal.

19. The POS system according to claim 15, wherein the store clerk terminal is configured to display, in response to an input operation, information of the item registered by the POS terminal together with the information regarding the payment processing.

20. The POS system according to claim 15, wherein the POS terminal is attachable to the shopping cart and configured to:
display a screen through which either online payment or checkout machine payment can be selected, and
upon selection of the online payment through the screen, issue the payment start request to the payment management server.
